(19) United States
(12) Patent Application Publication
(10) Pub. No.: US 2004/0253396 A1
(43) Pub. Date: Dec. 16, 2004

(54) Baby handy's baby wipes

(76) Inventor: Lisa Renee Robinson, Columbus, OH (US)

Correspondence Address: Lisa Robinson - Jarrell, 2431 East Shore Blvd. Apt. I, Columbus, OH, 43232, US

(21) Appl. No.: 10/624,035

(22) Filed: Nov. 1, 2003

Related U.S. Application Data
(60) Provisional application No. 60/479,083, filed on Jun. 16, 2003.

(51) Int. Cl. F16L 1/00

(52) U.S. Cl. 428/34.1

(57) ABSTRACT

A mitten-shaped baby wipe (FIG. 2), adjoined along edges, and (FIG. 1) opening for hand.

Thus, the scope of the invention should be determined by the appended claims and their legal equivalents, rather than by the examples given.

### CROSS REFERENCE TO RELATED APPLICATIONS

not applicable

### FEDERALLY SPONSORED RESEARCH

not applicable

### SEQUENCE LISTING OR PROGRAM

not applicable

### BACKGROUND OF INVENTION

Field of Invention

Grocery stores and supermarkets commonly supply consumers with rectangle-shaped baby wipes, which are hard to handle, and not reusable, after first use.

Baby Handy's Baby wipes are shaped to fit like a glove and more sanitary and convenient.

Specifications

Baby Handy's baby wipes are made by placing two cut-out mitten-shaped baby wipes, joining together along edges, except opening at the wrist bottom.

Baby Handy's baby wipes protect hands and nails from germs and mess; and baby bottoms from fingernails.

Baby Handy's are reusable when turned inside-out.

Thereafter, inventors created improvements: making baby wipes; thicker, scented, quilted, however, no more sanitary or convenient. Thus, baby wipes tend to be rectangle in shape, and do not cover entire hand from germs and babies are protected from fingernails.

### BACKGROUND OF INVENTION—OBJECTS AND ADVANTAGES

Accordingly, besides the objects and advantages of the mitten-shape described in my above patent, several objects and advantages of the present invention are as follows:

(a) To provide a baby wipe that covers hand completely, for better cleanliness.

(b) To provide a baby wipe whose production allows for a convenient and sanitary and economical change of shape in the baby wipes that are now being produced.

### SUMMARY

In accordance with the present invention a baby wipe comprises a flat body having a mitten-shape, and covers the hand from germs, and protects baby from fingernails. And when turned inside-out, may be used for extra cleaning.

### DRAWINGS—FIGURES

FIG. 1—show various aspects of baby wipe supplied with opening for hand.

FIG. 2—show mitten-shape with the adjoined edges, for better cleaning, and convenience.

### DRAWINGS—REFERENCE NUMERALS

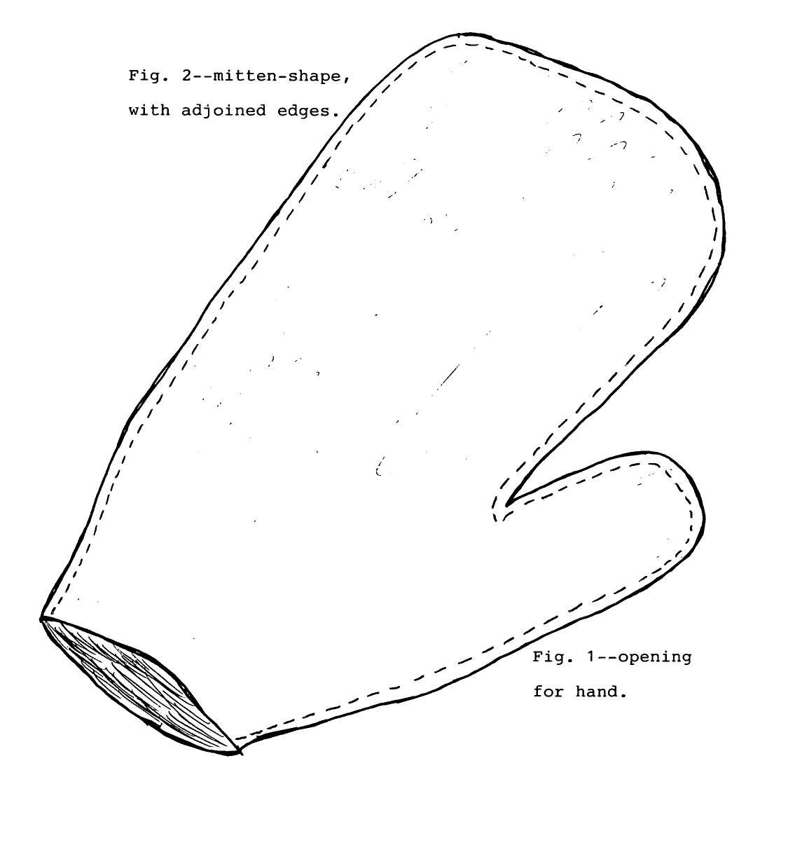

FIG. 1—hand opening

FIG. 2—mitten-shape wipe with adjoined edges.

Accordingly, the reader will see that the mitten-shape and adjoined edges, of this invention can be used to sanitarily clean children as well as adults, and when turned inside-out used again for excess cleaning.

1. What I claim as my invention is the mitten-shape of my Baby Handy's baby wipes.
